(19) United States
(12) Patent Application Publication
(10) Pub. No.: US 2010/0107984 A1
(43) Pub. Date: May 6, 2010

(54) Elevated Animal Feeding Apparatus

(76) Inventors: Michael Uffner, Naperville, IL (US); Michael R. Vogler, Oswego, IL (US)

Correspondence Address: MCHALE & SLAVIN, P.A., 2855 PGA BLVD, PALM BEACH GARDENS, FL, 33410, US

(21) Appl. No.: 12/264,418

(22) Filed: Nov. 4, 2008

(51) Int. Cl. A01K 1/10; A01K 5/01

(52) U.S. Cl. 119/61.5

(57) ABSTRACT

The present invention is directed toward animal feeding devices, and more particularly, to an elevated feeding apparatus for domestic animals such as dogs and cats. The device is constructed and arranged to be used for pet feeding with or without riser legs and provides space saving features for shipping and storage. As a space saving feature, the dish retainer is provided with a first fastener system positioned under the dish retainer so that riser legs can be stored in a nested state with respect to each other and within the confines of the perimeter wall. A second fastener system is provided near the distal ends of the dish retainer for attachment of the riser legs to elevate the dish retainer when desired.

### RELATED APPLICATION

This application is related to U.S. patent application Ser. No. 29/317,537, filed May 1, 2008, entitled Elevated Animal Feeding Bowl, the contents of which are incorporated herein in their entirety.

### FIELD OF INVENTION

The present invention generally relates to animal feeding devices, and more particularly, to an elevated feeding apparatus for domestic animals. The device includes riser legs constructed and arranged for storage in a nested state within the dish retainer so that the elevated animal feeding apparatus may be shipped in a nested state with other elevated feeding apparatus to conserve shipping space.

### BACKGROUND INFORMATION

Typically, animals such as dogs and cats are fed in dishes placed at floor level. It is known, however, that it may be injurious to the health of an animal, particularly a large animal, to eat at floor level. In addition, feed containers placed on the floor are easily accessible to crawling insects.

Thus, elevated pet feeders have been developed such as the pet dining table of Steininger (U.S. Pat. No. Des. 377,244) and the dog feeder of Fahmie (U.S. Pat. No. 4,065,195), which is composed of a top panel with holes to receive feeding pans, and three hinged support panels that hold the top panel above the floor level and may be collapsed in coplanar position to be portable. The pet feeder of Teschke (U.S. Pat. No. 4,699,089) elevates a removable feeding table by placing it on a feed storage container.

Another type of prior art pet feeder allows the pet owner to make adjustments for differently sized pets. For example, U.S. Pat. No. 4,044,723 of Fitzpatrick, discloses a table supported by legs to hold the food dishes. A plurality of legs of different lengths may be supplied with the table so that one set of legs may be replaced by another set of legs of a different length as is desired.

The feeding tray means of Brown (U.S. Pat. No. 4,658,759) has an elevated rectangular plate having extendible legs hinged to the bottom of the plate. The feeder holder of Altman (U.S. Pat. No. 5,429,071) provides two pairs of rigid L-shaped legs, each of which has slots so that U-shaped brackets may be inserted in opposing aligned slots to define a platform for holding a feeder above a pan of water to keep crawling insects from getting to the feed. The pet food serving apparatus of Mersits et al. (U.S. Publication No. US2003/0106498) also elevates a food tray above a moat, and may be adjusted in height by means of threaded leg sections, by vertical spacers, or by cut-out notches in the leg for insertion of the food tray.

The adjustable animal feeder of Lemkin (U.S. Pat. No. 6,145,474) has two molded plastic components: an upwardly opening hollow base, and a downwardly opening hollow cover for holding bowls. There are ribs spaced about the interior of the cover and grooves spaced about the perimeter of the base, so that when the cover is placed in one position, the ribs slide down the grooves and the bowls are in a lowered position, and when the cover is placed in another position, the ribs rest on the upper ends of the walls of the base and the bowls are in an elevated position.

The trough support of Swinney (U.S. Pat. No. 3,145,007) utilizes stanchions which have a trough carrying sleeve surrounding the stanchion, and a pawl and ratchet mechanism to change the height of the trough.

The adjustable pet feeding stand of Cooper (U.S. Pat. No. 3,651,787) has side walls with apertured leg portions, and apertured extensible support members that may be held in different positions with respect to the leg portions by means of fastening elements placed through the apertures.

Patents providing vertical structures upon which the height of feeders may be adjusted include U.S. Pat. No. Des. 424,758 of Akopdjanov (double bowl structure positionable at any one of a number of holes in the vertical structure), U.S. Pat. No. 4,205,629 of Wix (horizontal frame for holding bowls at different heights on a mounted support member), U.S. Pat. No. 5,000,124 of Bergen (wall mounting apparatus having a trigger and brake device so that bowl can be held at a particular elevation), U.S. Pat. No. 5,501,176 of Tully (bracket with horizontal slots has a tray attached to any one of the horizontal slots by means of a hinge), and U.S. Pat. No. 4,976,223 of Pierce (support base with at least two arms extending upwardly and having means to engage a food dish support plate).

Other adjustable feeders have multiple legs which may be adjusted in position to change the height of the feeder, such as U.S. Pat. No. 2,165,968 of Hill (legs adjusted longitudinally through slots.)

Many prior feeding devices have a very complicated or bulky structure making them difficult to construct and/or to move from position to position, or they are not adjustable in height at all, or have very limited adjustability.

Such prior art systems, while working well, have not met all of the needs of manufacturers to provide a product that can be easily manufactured, packaged and shipped or the needs of consumers requiring structural integrity combined with modularity, aesthetic appearance and ease of assembly.

Paramount among such needs is a component system which creates an elevated dog dish that can be shipped in a knocked-down state and assembled in a manner which resists component separation, buckling, and racking. Durability and weather resistance are further considerations; the elevated animal feeding apparatus formed by the components should connect together without the need for conventional screw or rivet type fasteners in such a way as to unify the entire structure.

There are also commercial considerations that must be satisfied by any viable elevated feeding apparatus or kit; considerations which are not entirely satisfied by state of the art products. The elevated feeding apparatus must be formed of relatively few component parts that are inexpensive to manufacture by conventional techniques. The elevated feeding apparatus must also be capable of being packaged and shipped in a knocked-down state. In particular, the device should be constructed and arranged for shipment and/or storage in a nested arrangement to conserve space and reduce shipping costs. In addition, the system must be modular and facilitate the creation of a family of elevated feeding apparatus that vary in appearance but which share common, interchangeable components.

Finally, there are ergonomic needs that an elevated feeding apparatus must satisfy in order to achieve acceptance by the end user. The apparatus must be easily and quickly assembled using minimal hardware and requiring a minimal number of tools. Further, the apparatus must not require excessive strength to assemble or include small component parts.

Therefore, there exists a need for an elevated animal feeding apparatus that may be shipped in a disassembled state and quickly assembled at a desired site with minimal hardware and minimal tools. The components utilized for assembly of the elevated feeding apparatus should be constructed and arranged to nest into the bottom portion of the feeding dish so that multiple dishes may be shipped and/or stored in a nested arrangement.

### SUMMARY OF THE INVENTION

Briefly, the present invention is directed toward animal feeding devices, and more particularly, to an elevated feeding apparatus for domestic animals such as dogs and cats. The device is constructed and arranged to be used for pet feeding with or without the riser legs and provides space saving features for shipping and storage when compared to prior art devices.

As a space saving feature, the dish retainer is provided with a first fastener system positioned under the dish retainer and within a depending perimeter wall surrounding the dish retainer so that the riser legs can be stored in a nested state with respect to each other and within the confines of the perimeter wall. A second fastener system is provided near the distal ends of the dish retainer for attachment of the riser legs to elevate the dish retainer when desired. In operation, a user may simply release the first fastener system to release the riser legs from beneath the dish retainer. The legs are thereafter simply slid into place, whereby the second fastener system snaps into engagement with the riser legs to hold them in place to elevate the dish retainer and the feeding dishes for the animal.

This construction provides multiple advantages over the prior art. First, it allows a user to purchase a single feeding apparatus that can be utilized as the animal grows in size. Second, it provides a storage area for the riser legs that eliminates the need to store loose parts prior to final assembly. Third, it provides a snap-together construction for adding the riser legs, eliminating the need for tools as well as eliminating the need for small loose fasteners and parts for assembly. Finally, the construction also permits multiple pet dish assemblies to be shipped in a nested state to conserve shipping as well as storage space.

Accordingly, it is an objective of the present invention to provide an elevated feeding apparatus having a set of riser legs that are constructed and arranged for snap-together assembly.

It is a further objective of the present invention to provide an elevated animal feeding apparatus that includes a first fastener system positioned under the dish retainer for storage of the riser legs in a nested state with respect to each other so that the dish can be used at a first elevation.

It is yet a further objective of the present invention to provide an elevated animal feeding apparatus having a second fastener system provided near the distal ends of the dish retainer for attachment of the riser legs to elevate the dish retainer when desired.

It is another objective of the instant invention to provide an elevated animal feeding apparatus that is constructed and arranged for shipment in nested arrangement.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a top perspective view of one embodiment of the instant invention;

FIG. 2 is a top perspective and partially exploded view of one embodiment of the instant invention;

FIG. 3 is a bottom perspective view of one embodiment of the instant invention;

FIG. 4 is a top perspective view of the embodiment shown in FIG. 1, illustrating the device with the riser legs in place;

FIG. 5 is a bottom perspective view of the embodiment illustrated in FIG. 4;

FIG. 6 is a top view of the embodiment illustrated in FIG. 4;

FIG. 7 is a bottom view of the embodiment illustrated in FIG. 4;

FIG. 8 is a side view illustrating the instant invention arranged in a nested state.

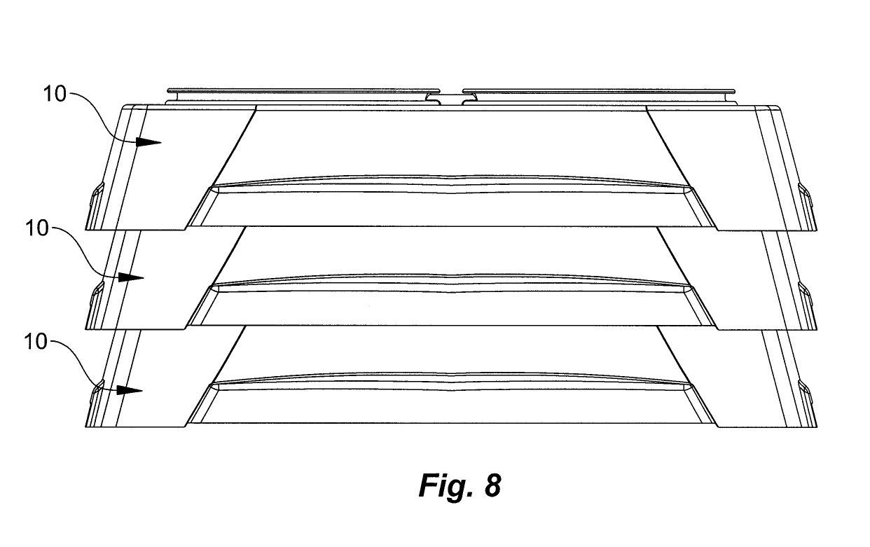

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

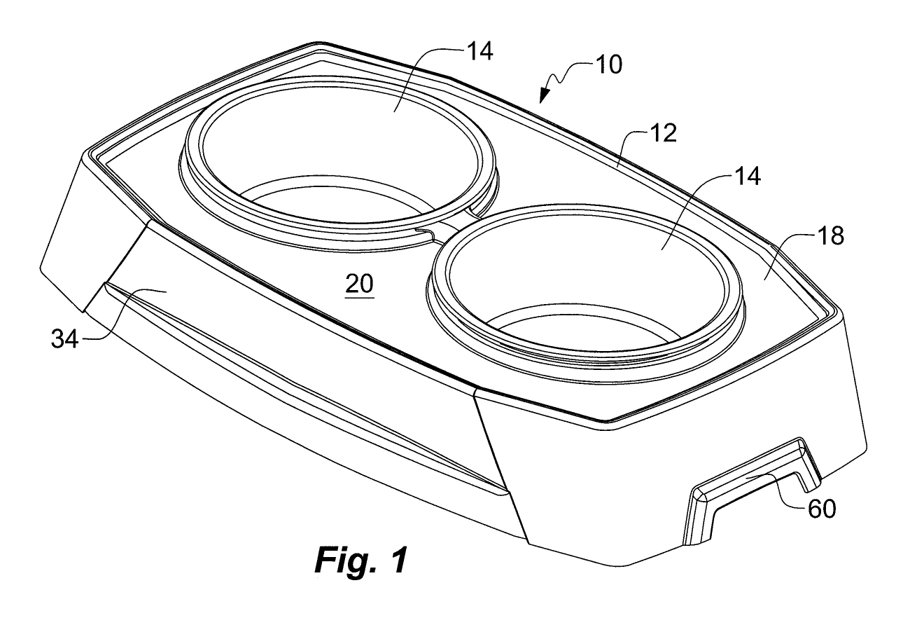

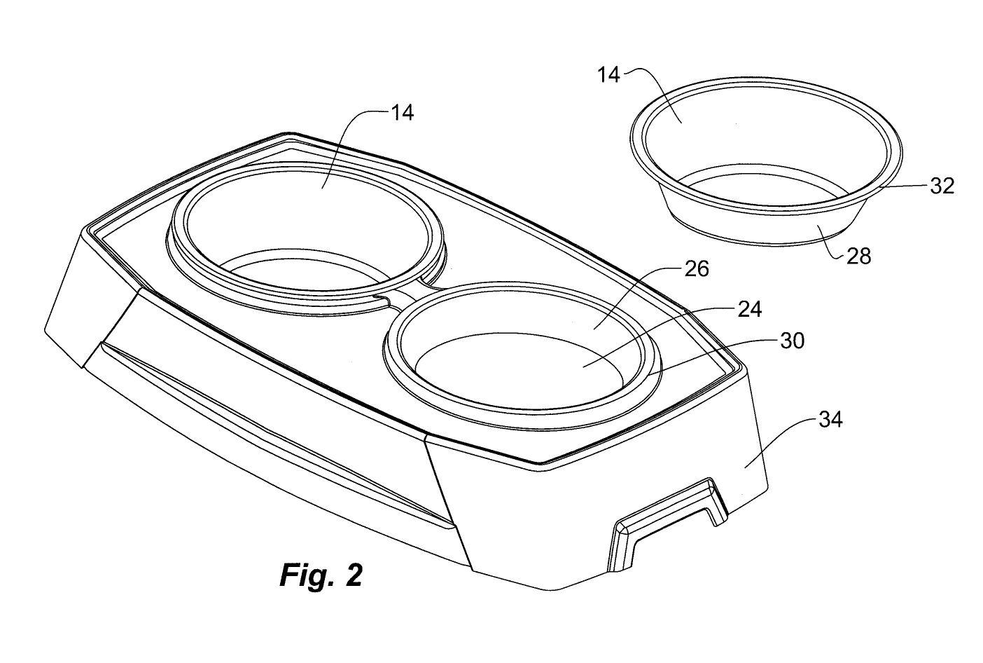

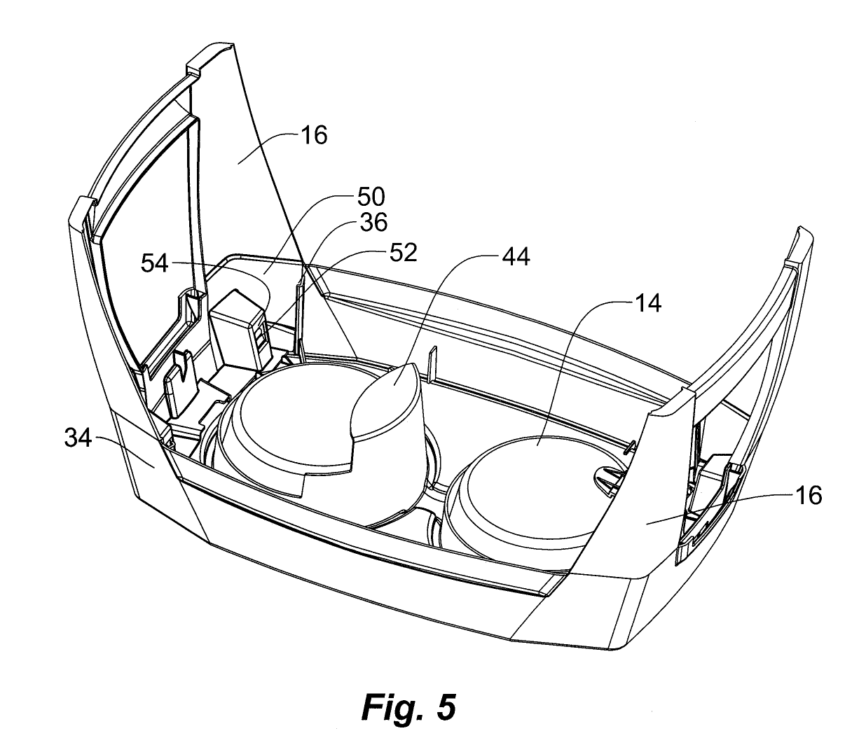

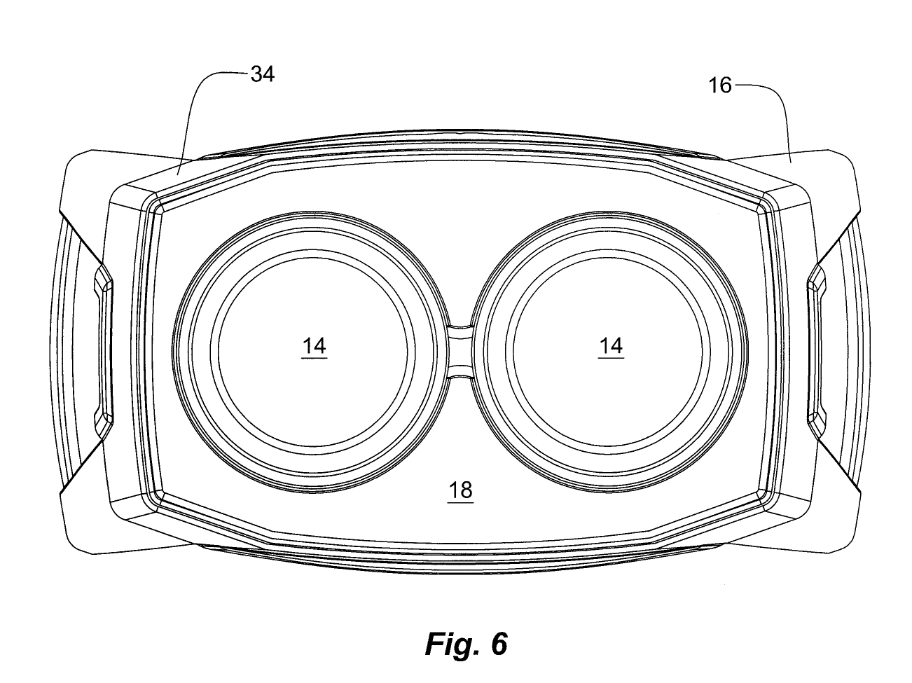

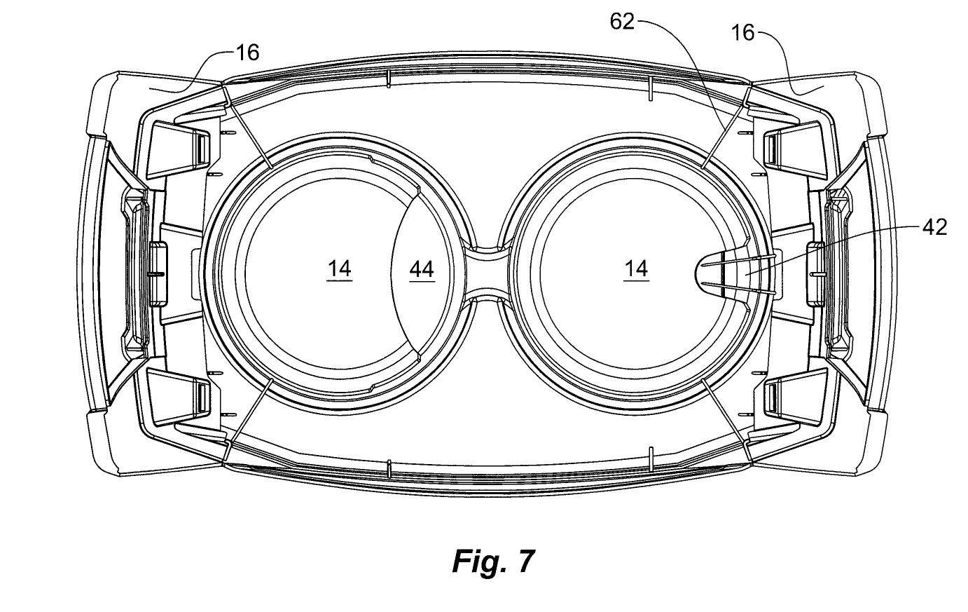

Referring generally to FIGS. 1-7, an elevated animal feeding apparatus 10 is illustrated. The apparatus generally comprises a dish retainer 12, at least one dish member 14 and a pair of riser legs 16. The dish retainer 12 is generally constructed and arranged to position at least one, and more preferably two, dish member(s) in such a manner so as to prevent an animal from tipping or moving the dish while feeding. In a preferred embodiment, the dish retainer includes a substantially horizontal portion 18 having top and bottom surfaces 20, 22 respectively. An aperture 24 (FIG. 2) is provided for each dish member 14. In one embodiment, each aperture includes a depending wall 26 that is substantially conjugate in shape to the side wall 28 of the dish member to provide additional stability to the dish member. An upstanding rim 30 may also be included for cooperation with a bottom surface of a perimeter ring 32 extending around an upper portion of the dish member 14. In this manner the dishes may be removed as desired for cleaning and/or filling and placed back into their respective position within the dish retainer.

Referring to FIGS. 1-3, the horizontal portion 18 of the dish retainer 12 preferably includes a depending wall 34 extending at least partially around its perimeter. The depending wall 34 includes a predetermined height and sufficient structural integrity to support the horizontal portion 18 of the dish retainer 12 a first distance from a ground surface. A bottom surface of the depending wall may also include feet (not shown) or anti skid surfaces to add additional stability to the structure.

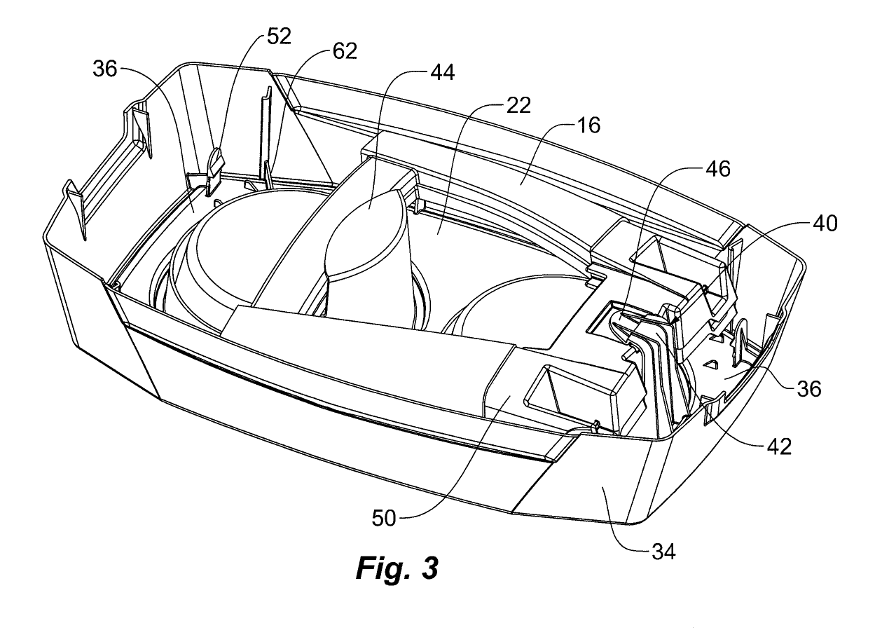

Referring to FIG. 3, a bottom perspective view of the animal feeding dish is illustrated. In this figure the riser legs 16 are illustrated in a storage/shipping position. A first fastener system 40 is provided on the bottom surface 22 of the horizontal portion 18. The first fastener system is constructed and arranged to secure at least two of the riser legs 16 in a nested arrangement that is substantially parallel to the horizontal portion. The first fastener system preferably includes at least one spring clip 42 and at least one hook member 44. In operation, the riser legs 16 are placed into a nested arrangement and a lower portion of the nested riser legs are placed within the hook member 44. The upper portion of the riser legs are then pushed toward the bottom surface of the horizontal portion so that the spring clip 42 flexes to engage the riser legs to retain the riser leg members in the storage position. A tab 46 is provided on the spring clip to allow a user to flex the spring clip for disengaging the legs from the storage position. It should also be noted that more than one spring clip or combinations of spring clips and hooks could be utilized without departing from the scope of the invention.

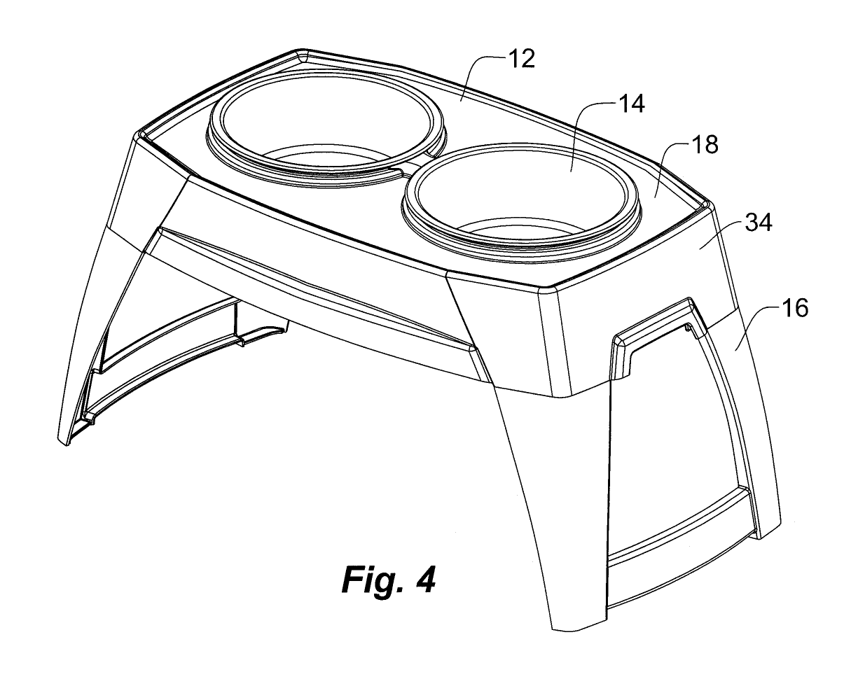

Referring to FIGS. 4-7, the animal feeding dish of the instant invention is illustrated with the riser legs secured in an upright position. In a preferred embodiment, the depending wall 34 also cooperates with the bottom surface of the horizontal portion to form a pair of sockets 36 (FIG. 3) that are positioned at opposite sides of the horizontal portion. The sockets are constructed and arranged to accept a contoured post 50 formed on an upper portion of the riser legs 16 in an interlocking manner so that the riser legs support the horizontal portion 18 at an elevated position with respect to the ground surface as is shown in FIGS. 4-7. The socket includes at least one spring lock 52 that is positioned to engage an aperture 54 formed into the contoured post so that the contoured post is secured within the socket.

The present invention provides an elevated animal feeding apparatus 10 that preferably includes injection molded components having integrated connectors which combine to form a family of variously sized elevated animal feeding apparatus. The components are preferably formed of injection molded plastic to create light-weight components having integrally formed ribs 60 (FIG. 1) and gussets 62 (FIG. 3) for strength and integrity. The injection molding also facilitates integrally formed connectors, e.g. the posts and sockets, so that the components interlock with one another without the need for separate connectors. The apparatus incorporates a minimum number of components to construct an elevated animal feeding apparatus by integrally forming apertures for dishes and integrally formed sockets constructed for interlocking cooperative engagement with contoured posts formed on the upper portion of the riser legs to rigidly connect the components together in a substantially perpendicular relationship. The symmetry of the riser legs also minimizes component shapes and simplifies elevated animal feeding dish construction. Injection molding the components allows them to be formed with various consumer convenience features such as anti-skid surfaces, gripping handles, anchoring apertures and the like.

What is claimed is:

1. An elevated animal feeding apparatus comprising:
a dish retainer constructed and arranged to position at least one dish member, said dish retainer including a depending wall extending at least partially around a perimeter of said dish retainer, said depending wall being constructed and arranged to support said dish retainer a first distance from a ground surface, said dish retainer including a first fastener system constructed and arranged to secure at least two riser legs in a storage position beneath a bottom surface of said dish retainer, said dish retainer including a second fastener system positioned on opposite side portions of said dish retainer, each said second fastener system constructed and arranged to cooperate with one of said at least two riser leg members in an interlocking manner so that said at least two riser legs support said dish retainer a second distance form a ground surface.

2. The elevated animal feeding apparatus of claim 1 wherein said first fastener system includes at least one spring clip, said at least one spring clip being constructed and arranged to flex between a lock position and a release position, whereby a portion of said spring clip engages said at least two riser legs in an interlocking manner, said interlocking engagement constructed and arranged to retain said at least two riser leg members in said storage position.

3. The elevated animal feeding apparatus of claim 2 wherein said first fastener system cooperates with said depending wall to retain said at least two riser legs within said depending wall.

4. The elevated animal feeding apparatus of claim 1 wherein said dish retainer includes at least one aperture therethrough, said at least one aperture sized to cooperate with a surface of said dish member for positioning thereof.

5. The elevated animal feeding apparatus of claim 1 wherein said second fastener system includes a socket constructed and arranged to accept and interlock with a contoured post positioned on an upper portion of each said riser leg to secure each said riser leg to said dish retainer in a second position, whereby said dish retainer is supported said second distance from said ground surface.

6. The elevated animal feeding apparatus of claim 5 wherein said socket includes at least one spring lock, said at least one spring lock positioned to engage a surface of said contoured post, whereby said contoured post is secured within said socket.

7. The elevated animal feeding apparatus of claim 6 wherein said at least one spring lock engages an aperture extending through a portion of said contoured post.

8. The elevated animal feeding apparatus of claim 1 including two dish members.

9. An elevated animal feeding apparatus comprising:
a dish retainer including a substantially horizontal portion having at least one aperture sized for cooperation with at least one dish member to position and stabilize said at least one dish member, a depending wall extending at least partially around said horizontal surface, said horizontal portion including a top surface and a bottom surface, said bottom surface including a first fastener system constructed and arranged to secure at least two riser legs substantially parallel thereto for storage thereof, said depending wall and said bottom surface forming a second fastener system for securing said riser legs to said retainer member in a substantially perpendicular position respective thereto, whereby said dish retainer is maintained at an elevated position with respect to a ground surface.

10. The elevated animal feeding apparatus of claim 9 wherein said first fastener system includes at least one spring clip, said at least one spring clip being constructed and arranged to flex between a lock position and a release position, whereby a portion of said spring clip engages said at least two riser legs in an interlocking manner, said interlocking engagement constructed and arranged to retain said at least two riser leg members for storage thereof.

11. The elevated animal feeding apparatus of claim 10 wherein said first fastener system cooperates with said depending wall to retain said at least two riser legs within said depending wall.

12. The elevated animal feeding apparatus of claim 9 wherein said dish retainer includes at least one aperture therethrough, said at least one aperture sized to cooperate with a surface of said dish member for positioning thereof.

13. The elevated animal feeding apparatus of claim 9 wherein said bottom surface and said depending wall cooperate to form a socket, said socket constructed and arranged to accept and interlock with a contoured post positioned on an upper portion of each said riser leg to secure each said riser leg to said dish retainer in a second position, whereby said dish retainer is supported above said ground surface.

14. The elevated animal feeding apparatus of claim 13 wherein said socket includes at least one spring lock, said at least one spring lock positioned to engage a surface of said contoured post, whereby said contoured post is secured within said socket.

15. The elevated animal feeding apparatus of claim 13 wherein said at least one spring lock engages an aperture extending through a portion of said contoured post.

16. The elevated animal feeding apparatus of claim 9 including two dish members.
